(19) United States
(12) Patent Application Publication
(10) Pub. No.: US 2007/0219824 A1
(43) Pub. Date: Sep. 20, 2007

(54) System and method for identifying and analyzing patterns or aberrations in healthcare claims

(76) Inventors: Jean Rawlings, Roy, UT (US); Jonathan B. Arthur, Hudson, WI (US); David R. Anderson, Chaska, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/384,231

(22) Filed: Mar. 17, 2006

(51) Int. Cl. G06Q 10/00; G06Q 40/00

(52) U.S. Cl. 705/2; 705/4

(57) ABSTRACT

In a system and method for identifying aberrations in treatment pattern for a medical condition, a group of healthcare claim data to be analyzed is identified, wherein the group of healthcare claim data to be analyzed includes claim data representing treatment of the medical condition. Actual treatment pattern data is generated that represents the claim data in the group of healthcare claim data to be analyzed. Defined treatment pattern data for the medical condition is retrieved and compared to the actual treatment pattern data to identify one or more discrepancies therebetween, and corresponding comparison data representing the results of the comparison is generated. The actual treatment pattern data may represent a patient's treatment for the medical condition, and the defined treatment pattern data may represent treatment of a group of other patients for the medical condition. Alternatively, the actual treatment pattern data may represent treatment of multiple patients for the medical condition by a healthcare provider, and the defined treatment pattern data may represent an established procedure for treatment of the medical condition. The system and method may also generate the defined treatment pattern data by identifying and compiling claim data relating to treatment of the medical condition from a database of historical claim data.

### FIELD OF THE INVENTION

This invention relates, in general, to data processing techniques, and more specifically to analyzing healthcare data.

### BACKGROUND OF THE INVENTION

In the healthcare industry, payers of medical claims face the challenge of identifying and preventing healthcare fraud and abuse. One industry-wide effort relates to establishing rules engines that provide the capability to prevent payment to fraudulent claims. Several analytic tools are available, such as products offered by IBM (FAMS), Fair Isaac, and VIPS, but these products have minimal interoperability, operate very slowly in a traditional reporting fashion and/or require significant configuration, and require an intense effort to modify. Tools like SAS and SPSS provide statistical analysis capability to review very large data sets but they require either a predefined binary target or a test data set in order to derive relevant aberrancy patterns within the claims data. However, such tools may require significant upfront consulting fees, and the accuracy of such tools may be compromised during use.

Additionally, existing systems often focus on identification of aberrations or fraud in the context of claim data associated with an individual patient. However, some types of fraud are difficult to detect on an individual basis. Thus, there is a need for a system that can identify fraud and other claim data aberrations (e.g., billing irregularities) based upon analysis of groups of claim data.

As recognized by the present inventors, what is needed is a method and system for identifying and analyzing patterns of healthcare claims, so that fraud or other patterns of interest may be identified from the healthcare claims. It is against this background that various embodiments of the present invention were developed.

### SUMMARY

In light of the above and according to one broad aspect of one embodiment of the present invention, disclosed herein is a method for identifying aberrations in a patient's treatment pattern for a medical condition, aberrations in treatment patterns representing treatment of a number of patients for the same medical condition by one or more healthcare providers, or aberrations in patterns based upon other claim data groupings as desired by the user. Aberrations in treatment patterns identified by the system and method may be indicative, for example, of fraud, improper or poor quality of medical treatment, improper billing practices, and/or other undesirable aspects of treatment of the medical condition.

In one embodiment of the present invention, a method for identifying aberrations in treatment pattern for a medical condition includes the steps of: identifying a group of healthcare claim data to be analyzed, wherein the group of healthcare claim data to be analyzed includes claim data representing treatment of the medical condition; generating actual treatment pattern data representing the claim data in the group of healthcare claim data to be analyzed; retrieving defined treatment pattern data for the medical condition; comparing the actual treatment pattern data to the defined treatment pattern data to identify one or more discrepancies therebetween; and generating comparison data representing the results of the comparison. The method may further include the step of displaying the actual treatment pattern data, the defined treatment pattern data, and the comparison data and/or the step of generating the defined treatment pattern data by identifying and compiling claim data relating to treatment of the medical condition from a database of historical claim data.

The actual treatment pattern data may represent a patient's treatment for the medical condition, and the defined treatment pattern data may represent treatment of a group of other patients for the medical condition. Alternatively, the actual treatment pattern data may represent treatment of multiple patients for the medical condition by a healthcare provider, and the defined treatment pattern data may represent an established procedure for treatment of the medical condition. The actual treatment pattern data may include treatment dates, categories of treatment, and a list of treatments provided.

The established procedure may be derived from evidence based medicine and/or from historical claim data analysis.

A system for identifying aberrations in treatment pattern for a medical condition in accordance with the present invention includes a database for storing healthcare claim data and a processor. The processor identifies a group of healthcare claim data to be analyzed, wherein the group of healthcare claim data to be analyzed includes claim data representing treatment of the medical condition; generates actual treatment pattern data representing the claim data in the group of healthcare claim data to be analyzed; retrieves defined treatment pattern data for the medical condition; compares the actual treatment pattern data to the defined treatment pattern data to identify one or more discrepancies therebetween; and generates comparison data representing the results of the comparison.

The features, utilities and advantages of the various embodiments of the invention will be apparent from the following more particular description of embodiments of the invention as illustrated in the accompanying drawings.

### BRIEF DESCRIPTION OF THE DRAWINGS

FIG. 1 illustrates an example of a block diagram for identifying and analyzing patterns of healthcare claims, in accordance with one embodiment of the present invention.

FIG. 2 illustrates an example of operations for identifying and analyzing patterns of healthcare claims in accordance with one embodiment of the present invention.

FIG. 2A illustrates another example of operations for identifying and analyzing patterns of healthcare claims in accordance with one embodiment of the present invention.

FIG. 3 illustrates an example of a display layout for pattern analysis of healthcare claims data, in accordance with one embodiment of the present invention.

FIG. 4 illustrates an example of a display layout to analyze treatment patterns received by a group of patients having a medical condition, in accordance with one embodiment of the present invention.

FIG. 5 illustrates an example of a display layout wherein a comparison or overlay of individual treatments and group treatment is illustrated, in accordance with one embodiment of the present invention.

FIG. 6 illustrates an example of a display screen of a geographic market report of claims data, in accordance with one embodiment of the present invention.

FIG. 7 illustrates an example display screen of a chapter 5 sub category/diagnosis selection screen, in accordance with one embodiment of the present invention.

FIG. 8 illustrates an example display screen of medical service providers organized by regions, in accordance with one embodiment of the present invention.

FIG. 9 illustrates a geographic map of members of a healthcare plan that have received a particular medical diagnosis, in accordance with one embodiment of the present invention.

FIG. 10 illustrates an example display screen of a regional 15 pattern for a particular medical diagnosis, in accordance with one embodiment of the present invention.

FIG. 11 illustrates an example display screen of a profile of diagnosis codes used rarely and commonly by a particular medical service provider, in accordance with one embodiment of the present invention.

FIG. 12 illustrates an example display screen of a geographic map showing a medical service provider's member distribution, in accordance with one embodiment of the present invention.

FIG. 13 illustrates an example display screen of healthcare claims data corresponding to a particular medical service provider, in accordance with one embodiment of the present invention.

FIG. 14 illustrates an example display screen of a treatment pattern as provided by a particular medical service provider for a particular medical diagnosis, in accordance with 10 one embodiment of the present invention.

FIG. 15 illustrates an example display screen of a overlay or comparison between a healthcare pattern provided by a service provider for a particular diagnosis as compared with a pattern generated from evidence based medicine, in accordance with one embodiment of the present invention.

FIG. 16 is an example of a classification of categories for analyzing healthcare claims data, in accordance with one embodiment of the present invention.

FIG. 17 is an example of a traversing the classifications of categories for analyzing healthcare claims data, in accordance with one embodiment of the present invention.

FIG. 18 is a further example of traversing the classifications of categories for analyzing healthcare claims data, in accordance with one embodiment of the present invention.

FIG. 19 is an example of mapping a problem statement and a solution to the classification of categories of FIG. 18, in 5 accordance with one embodiment of the present invention.

### DETAILED DESCRIPTION

Embodiments of the present invention provide for deriving healthcare treatment patterns for a patient from healthcare claims data and displaying such treatment patterns. These treatment patterns can be compared to group treatment patterns derived from healthcare claims data, so that aberrations in the patient's treatment pattern can be identified. These aberrations can help identify fraud, over utilization, or other problems. Moreover, using the patient's treatment patterns, if any combinations of events of interest occurred to the patient (i.e., such as an adverse drug reaction), such events of interest can be located to the extent they may have occurred in other patient's healthcare claims data.

In one example, graphical user interfaces or display screens allow users to quickly drill down on data associated with aberrant billing patterns, identifying claim ID, provider, specialty, regions, state, employer, diagnosis code, procedure code, etc., and any combination of one or more data points. The user interfaces can be used to identify types of trends that exist in the data and target the factors that may be related to such trends. Various embodiments of the present invention are described herein, and may be implemented as methods, systems, apparatus or in other forms.

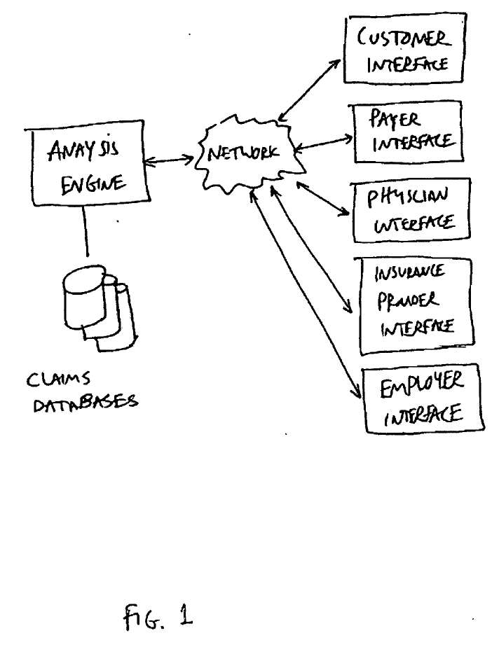

FIG. 1 illustrates a block diagram of a system for identifying and analyzing patterns of healthcare claims, in accordance with one embodiment of the present invention. As shown in FIG. 1, an analysis engine is provided which reads and processes data from a database of healthcare claims. In one example, the database may include multiple information sources having healthcare claims data. In one example, a conventional claims database is utilized which contains data, including IDC9 code data, of medical claims. In one example, the database may include procedure code descriptions, such as a CPT code, for each claim line item. The data may also include ICD-9 codes, which are an International Classification of Disease indicating why a particular procedure or medical service was performed, also known as a “diagnosis” codes.

To create groupings of claim data to be analyzed for patterns and aberrations in accordance with the present invention, claim data may be grouped using any grouping methodology or definition desired by the user. For example, groupings of claim data to be analyzed by the analysis engine may be episode treatment groups (ETGs), which define a grouping of medical episodes of related etiology. A detailed description of the grouping of medical claim data into ETGs is described in U.S. Pat. No. 6,223,164 B1, issued Apr. 24, 2001 to Seare et al., and U.S. Pat. No. 6,370,511 B1, issued Apr. 9, 2002 to Dang, both of which are incorporated herein by reference. Groupings of data may be performed by the medical service provider or by the facility where the service is provided.

Various interfaces may be provided to the analysis engine, including interfaces for customers, interfaces for payers, interfaces for physicians, interfaces for insurance providers, and interfaces for employers, as examples. Each of these interfaces may be implemented over a network, for instance within a browser program of the user for providing remote access to the analysis engine and the data stored in the claims database.

Generally, the analysis engine allows for identification of patterns present in healthcare treatments of individual patients or groups of patients. These patterns have numerous uses as described herein, for instance for comparing a pattern of treatment received by an individual patient against the general pattern of treatment of a group of patients having the same medical condition as the individual patients.

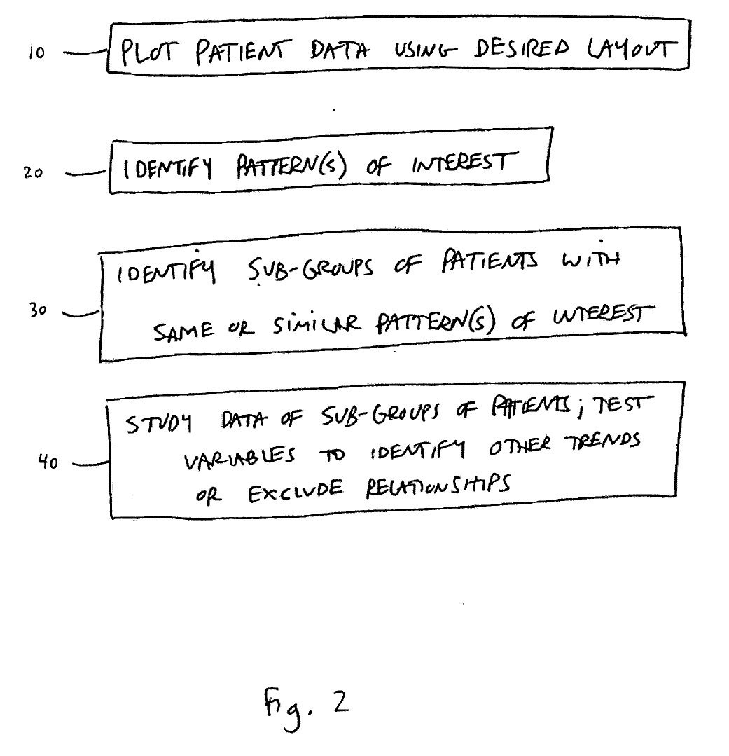

FIG. 2 illustrates an example of operations for identifying and analyzing patterns of healthcare claims, in accordance with one embodiment of the present invention. At operation 10, a display of patient data is created using a desired display layout. Numerous examples of display layouts are described herein. In one example, the display layout includes treatments data and categories of services rendered, and may also include diagnosis codes and a list of actual services received. The category of services may be arranged to include categories such as maintenance services, complication services, surgery services, lab/radiology services, and pharmacy services, and one example. At operation 20, using the display of operation 10, patterns of interest with respect to the patient's treatment are identified. There may be a multitude of patterns of interest that may be identified, and may include, but are not limited to: excess prescriptions of medicines, skewed frequencies of treatments or office visits, the onset of a major medical acute condition, etc.

Using the patterns of interest identified in operation 20, subgroups of patients with the same or similar pattern of interest may be identified. In one example operation 30 includes mining the claims database for additional patients which may also have experienced the same or similar pattern as identified by operation 20. In this regard, where a pattern of interest identified in operation 20 includes, for example, an adverse reaction to a medical treatment or a combination of drugs, operation 30 can mine the claims database to determine if other patients have experienced similar adverse reactions.

In operation 40, the data of the subgroups identified by operation 30 can be studied and variables within the data set can be isolated to identified other trends. For instance, where a subgroup of patients has experienced and adverse reaction to a medical treatment or combination of prescribed drugs, operation 40 may examine whether the patients in the subgroups have other traits in common or other statistical analysis may be performed. Hence operations 20-40 can be used to examine whether a pattern of interest that the individual patient experienced was also experienced by other patients whose records are in the claims database.

In another embodiment, in place of operations 20-40, a set of operations can be performed to identify aberrations in the treatment pattern of an individual patient when compared against a group of patients have the same medically diagnosed condition. In one example, a group treatment pattern as received by a group of patients for the medical condition is derived from the healthcare claims data and this group treatment pattern is compared to the first display to one or more discrepancies therebetween. A second display of the group treatment pattern may be provided, and the first display and the second display may be combined to visually display the one or more discrepancies between patterns of treatment.

FIG. 2A illustrates an alternative operation for identifying and analyzing patterns of healthcare claims in accordance with the present invention. In step 210, the analysis engine of FIG. 1 identifies a group of claim data to be analyzed, such as claim data relating to treatment of a certain medical condition, e.g., condition X, by a certain healthcare provider, e.g., provider A. The group of claim data may be defined by gathering all ETG claim data for the condition X where the provider of care is provider A.

In step 220, the analysis engine creates pattern data illustrating all treatments given to patients of provider A relating to the treatment of condition X.

In step 230, the analysis engine retrieves from an associated database the applicable predefined pattern of treatment for condition X. The predefined pattern of treatment may be, for example, defined based upon evidence based medicine standards or defined through historical claim analysis. The predefined pattern of treatment for condition X may be defined to take into account factors such as the difficulty of the treatments provided by provider A and/or provider A's casemix. By considering the applicable casemix, provider A's treatment patterns are compared with other healthcare providers that have a similar casemix. By considering the applicable staging indicators (e.g., risk of mortality or severity of illness), provider A's treatment patterns are compared against treatment of condition A at similar levels of difficulty or complications.

In step 240, provider A's treatment patterns are compared against the predefined treatment pattern retrieved by the analysis engine and displayed to the user. Using this method, the user may identify, for example, unusual, unnecessary, and/or excessive treatments routinely provided by provider A in treatment of condition X; unusual, unnecessary, and/or excessive use of facilities by provider A in treatment of condition X; and/or unusual, unnecessary, and/or excessive billing practices by provider A. Identification of such aberrations may be indicative of fraud, poor quality of care, billing irregularities, etc., that may be difficult to detect when examining claim data relating only to one patient being treated by provider A for condition X. The results of this comparison may be used, for example, to generate reports concerning treatment patterns of certain healthcare providers to enable assessment of the performance of the healthcare provider for various purposes. Similar analyses may be performed for multiple medical conditions and/or multiple healthcare providers.

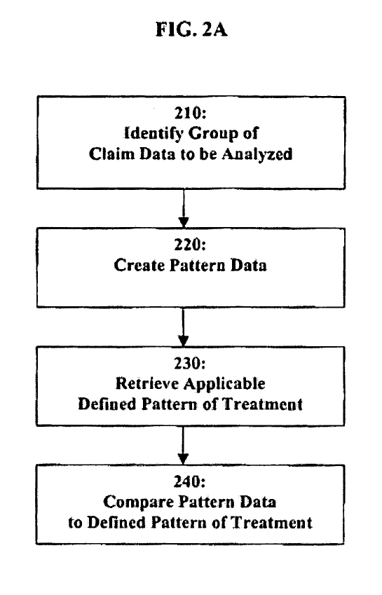

FIG. 3 illustrates an example of a display layout for pattern analysis of healthcare claims data performed using the process illustrated in FIG. 2. In this example, claims data relating to historical healthcare treatment of an individual patient is illustrated. In this example, the display layout includes data representations of treatment dates, diagnosis codes, and categories of healthcare services. In one example, the treatment dates are plotted in ascending order along the lower horizontal axis from left to right, and the left most vertical axis includes the category of healthcare services. The category of healthcare services may include various subcategories, such as a maintenance subcategory, a subcategory for complications, a subcategory for surgery, a subcategory for laboratory work or radiology, a subcategory for pharmaceuticals or prescriptions, and the like. Depending upon the particular implementation, the subcategories used in the display layout may vary.

The display layout may also include a list of services received, or representation thereof, which may be arranged to be displayed within each subcategory to which the particular service corresponds. It can be seen that for each data point based on actual healthcare claim data, the data point is plotted to correspond with the date of the treatment, and is also plotted to be displayed within the appropriate category of services provided. Moreover, in one example, for each data point, the diagnosis codes relating to that data point may be displayed, as well as a description or representation of the actual services performed.

In this example, the patient has been categorized in a group of patients having the medical condition of leukemia. By grouping the patients into various groups based on the medical conditions they suffer from, treatment patterns for all such patients in a particular group can be identified, and variations of treatments received by individual patients can be readily identified when compared against the pattern of treatment that other patients in the group receive.

Further, if desired, each data point may include the actual cost associated with the medical service or event that occurred and is represented by that data point.

Using a display layout such as illustrated in FIG. 3, actual healthcare claims data events can be plotted within the display layout. For instance, in FIG. 3, the first service received for this individual patient analysis was on Jan. 1, 2002, and included an “Executive Profile 80053” that is displayed within the category of laboratory/radiology services. That event included diagnosis codes V581 and 205.10 in this example. It can be seen that the next events that occurred in time based on the healthcare claims data were the prescriptions of medicine including “GLEEVEC 100 mg 25724” and “ALLOPURINOL 300 mg 7037.” Later in time, approximately around Apr. 1, 2002, the patient received an office visit, had some blood work performed, and received an automated hemogram and executive profile laboratory/radiology work. Three more drugs were prescribed (TENORETIC 50 mg 6779, INDOMETHACIN 50 mg 5084, and GLYBURIDE MICRO 6 mrx, 16602).

The other services received by this patient during the course of their healthcare treatment are shown in this example FIG. 3. From this display layout, it can be seen that prior to May 1, 2003, the patient suffered a major coronary complication that included emergency care. Accordingly, because the display layout of this example provides historical healthcare claims data, such a display layout permits a medical practitioner or other entity to quickly examine the history of treatment to determine whether a significant or meaningful pattern exists in the treatment, and can help identify whether a variation in treatment has been experienced by a patient when compared with typical patterns for treating a patient with similar medical issues.

Accordingly, the display layout of FIG. 3 provides a simple visual display where a pattern change can be identified quickly (in this case, the major coronary event that occurred prior to May 1, 2003) and such pattern change can be isolated with an analysis of what occurred prior to the complication. In this case, it can be seen that immediately prior to the complication, a new drug “MONOPRIL 20 mg 3877” was added to this patient's treatment regiment. At this point in the analysis, a comparison may be made with other patients in the system to determine whether other patients may have the same or similar pattern of treatment that resulted in a coronary event. Because the claims data base in the system includes claims data of various treatments for millions of patients over numerous years, it may be possible to identify similar situations in other patients. Such results could then be used to initially identify potential adverse side effects of medications or adverse interactions between two or more drugs. Once a pattern of interest has been identified (such as a potential adverse side effect or adverse drug interaction) further data processing can be performed by isolating or analyzing a subset of patients who experienced the particular pattern or adverse side effect. For instance, of the subset of patients, the claims data may be further examined to determine whether there is an indication in the patient's body that may be responsible for the adverse reaction, such as a type of gene, co-morbidity, patient weight, other medical conditions such as diabetes or other variables. Additional information concerning analysis of safety concerns for new drugs is found in U.S. Provisional Patent Application Ser. No. 60/674,958, entitled “System and Method for Early Detection of Safety Concerns for New Drugs,” filed Apr. 25, 2005.

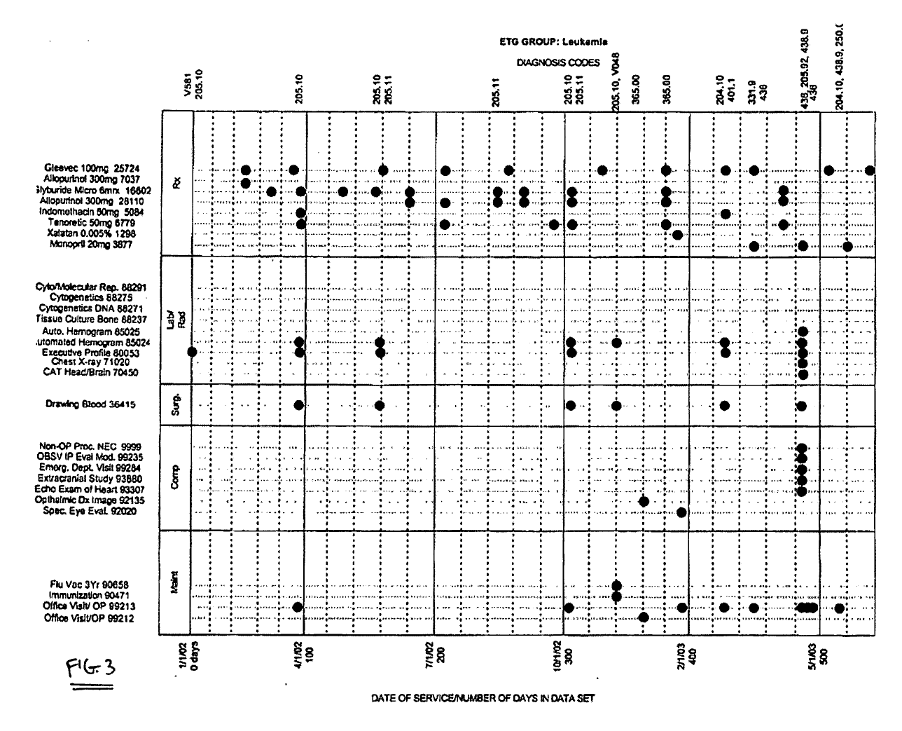

FIG. 4 illustrates an example of a display layout to show a pattern of treatment received by a group of patients. In this example, the group of patients each have the medical condition of leukemia, the same condition as the individual patient whose pattern of care is represented in FIG. 3. As with the display layout of FIG. 3, in the layout of the example of display of FIG. 4, when displaying group behavior, treatment dates are typically normalized around an anchor date which might be day 0—first diagnosis, or day 0—start of treatment, and may further include diagnosis codes and representations of actual services received, or categories of services provided. In FIG. 4 the data points shown may be derived from the database of claims data. Moreover, each data point can include average or typical costs for each medical procedure or event represented by the particular data point.

In the example of FIG. 4, it can be seen that the group of patients having leukemia experienced a general treatment program that includes a steady set of immunizations, office visits at least every six months, periodic blood draws and hemograms, as well as eye examinations and prescriptions of “Glyburide micro 6 mrx 16602.”

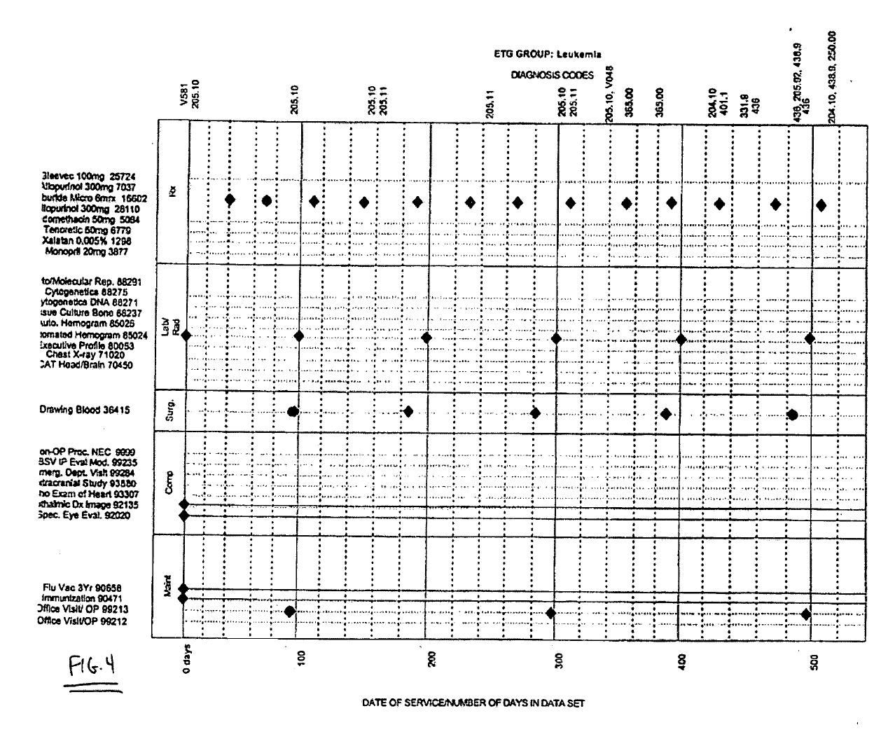

The patterns of treatment such as shown in FIG. 4 can be used for comparison against an individuals' actual treatment history or against a group of individuals' treatments histories or patterns thereof, as shown below with regard to FIG. 5.

In the example of FIG. 5, the individual's actual treatment (FIG. 3) is compared against a pattern of treatment received by a group of patients having the same medical condition (FIG. 4). Hence, using the overlay of FIG. 5, it is possible to compare how an individual's treatment was similar to or different from the typical pattern of treatment received by patients having the same or similar medical condition, and aberrations in the individual's treatment pattern can be identified. In the example of FIG. 5 for instance, the overlay display indicates that the individual patient received their flu vaccine and immunization, as well as their diagnostic ophthalmologic exams and special eye exams, consistent with those received by the group of patients. In contrast, the patient received a large number of chest x-rays which was inconsistent with the treatment pattern of the group. FIG. 5 also illustrates a number of other differences between the treatment received by the individual and the pattern of treatment received by the group of patients.

Using the display layout of FIG. 4, patterns of treatment for patients having a particular diagnosis, or access patterns for a particular diagnosis, can be created from actual medical claims data to provide evidence based medicine patterns derived out of the data. Patterns analyzed based on evidence based medicine are identified by analyzing claims from patients' medical records or claim stream from a particular healthcare provider to test the provider's compliance with standard guidelines, such as rules from published scientific investigations, published pharmacy safety information, and/or expert opinion, billing practices, etc. A comparison between the standard guidelines and patterns in patients' treatment data may be used to identify aberrations in the provider's conduct.

Alternatively, a pattern can be introduced into the display layout, and that pattern can be compared to entries within the claims data base. For instance, a pattern of best practices or best treatment practices can be introduced and then used for comparison purposes against other patterns derived from the claims data or compared against treatments received by individuals or by groups of individuals represented within the claims database. Other patterns may include patterns by specialty group, patterns of quality in which actual treatment patterns are compared to predefined treatment patterns to assess the quality of care provided to one or more patients and/or provided by one or more healthcare providers, patterns of physician's treating habits to see how often a physician sees patients, patterns of over utilization and under utilization, and patterns of wellness programs.

Embodiments of the present invention may be used to notify insurance providers and their members of fraud because the display layouts may be used to examine the ways in which the patients are receiving care. For instance, if the diagnosis codes don't support the services or prescriptions being received by a patient, such may indicate fraud.

Embodiments of the invention may also be used as case management tools, because particular patterns of best treatment practices can be matched up with physicians who empirically treat their patients according to such best practices, and hence new patients with such conditions can be referred to those physicians.

For example, employers may use embodiments of the inventions to help design or adjust their medical benefit programs. Employers can perform sensitivity analysis to study potential costs or effects of changes in health care policies.

For instance, if the employer or a payer is proposing to change co-payments for office visits from $15 to $20, the employer or payer can retrieve and study the general access pattern for the groups of employees and determine whether the change in the co-payment amount will result in any cost savings.

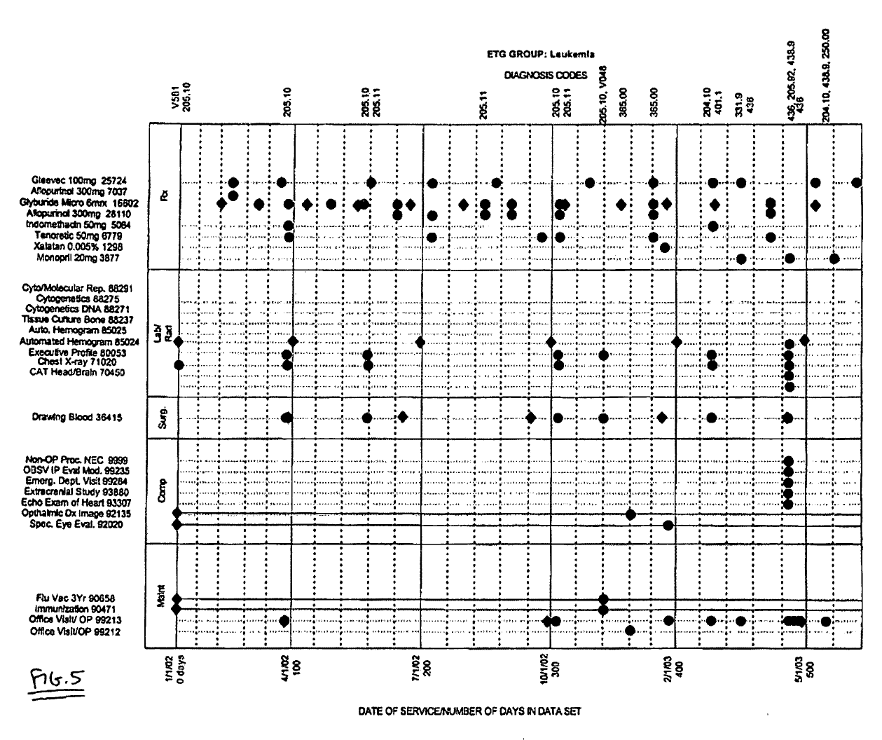

FIG. 6-15 illustrate examples of display screens which may be utilized with one or more embodiments of the present invention. In FIG. 6, a trend analysis or geographic market report is illustrated which may be useful for viewing by a payer to determine where insurance costs are originating from on a per member per month basis, in one example. In FIG. 6, a target per member per month cost is shown for physician visits, in-patient treatment, and out-patient treatment, as well as per member per month actual cost of physician visits, in-patient treatments and out-patient treatments. A per member per month trend field is also provided for physician visits, in-patient services, and out-patient services. For instance, in the first row of data from the market of New York, it can be seen that for a first group of claim types relating to connective tissue, the actual per member per month costs of physician visits is $17.94 versus a projected target per member per month cost of $15.73, expressed as a trend difference of 1.6%. The user of the software is able to drill down deeper into these numbers by selecting one or more links provided in the example display screen of FIG. 6.

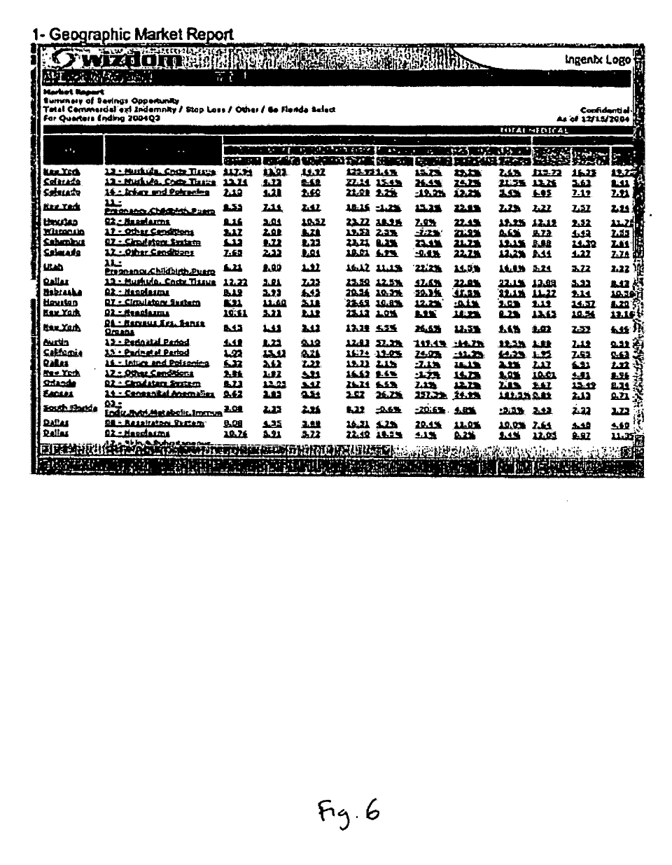

FIG. 7 illustrates an example display screen wherein a search window is provided so that a user can conduct a search of data for a particular markets and for a particular diagnosis code categories. The display screen provides a display of the number of patients, and encounters and providers in the data set, as well as the averages of the net amounts paid per patients per encounter, or per provider.

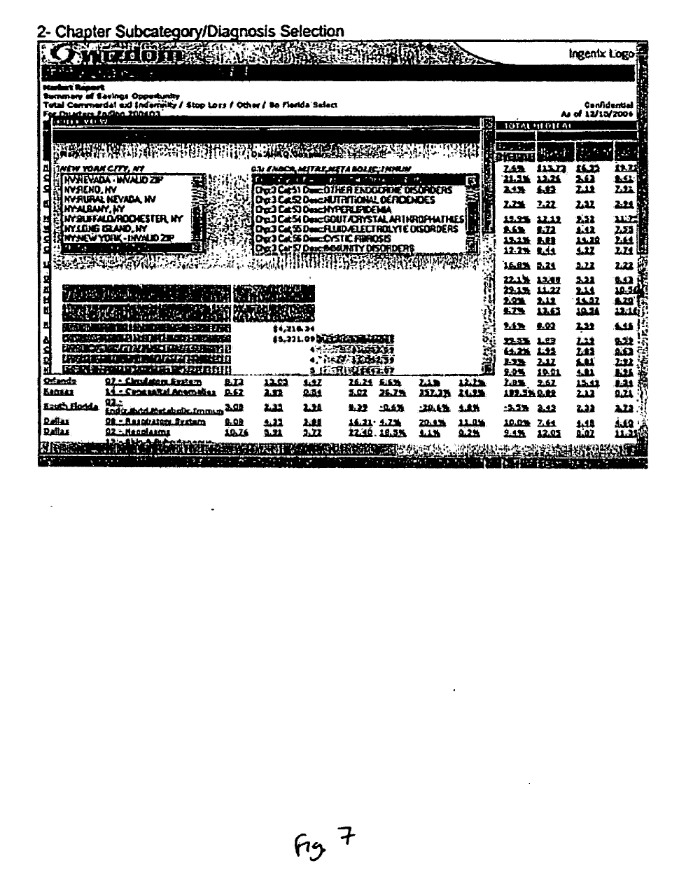

FIG. 8 illustrates an example display screen showing costs by market region, and also includes names of providers, specialty of providers, diagnosis code categories, and the net amounts paid, amounts covered, and number of unique patients, encounters, and providers in the data set. For instance, this display screen can be used by a payer to see that $981.39 is being paid per member per month to medical service provider Dr. John M. Smith. If the user desires to see more information about the patients and claims of John Smith, the user can select the link to John Smith and further information may be displayed.

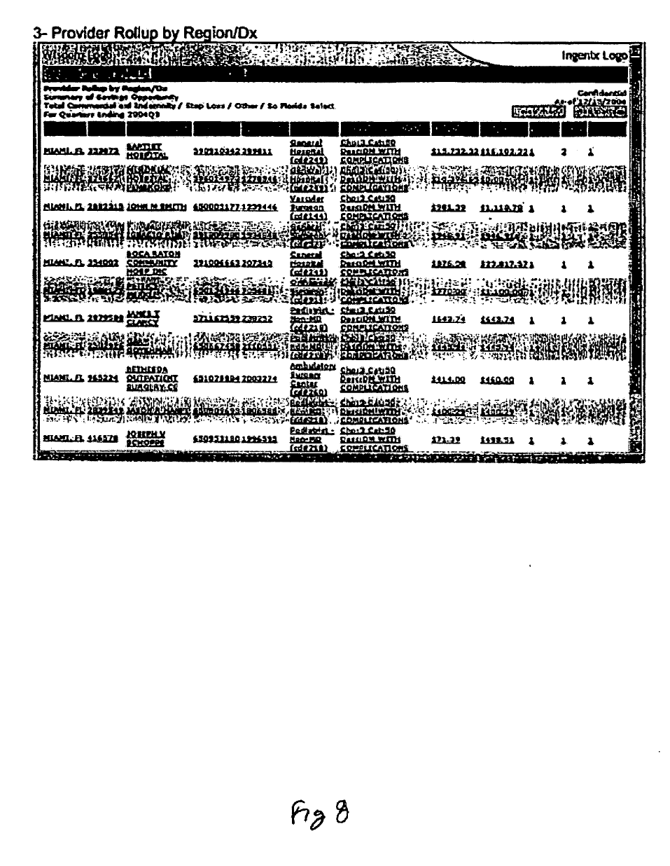

FIG. 9 illustrates an example of a geographic map showing the location and distribution of members that have experienced the same diagnosis as was diagnosed by Dr. John Smith. If a user clicks on a portion of the map, then further information may be displayed about the treatment that patients in that geographic region are receiving.

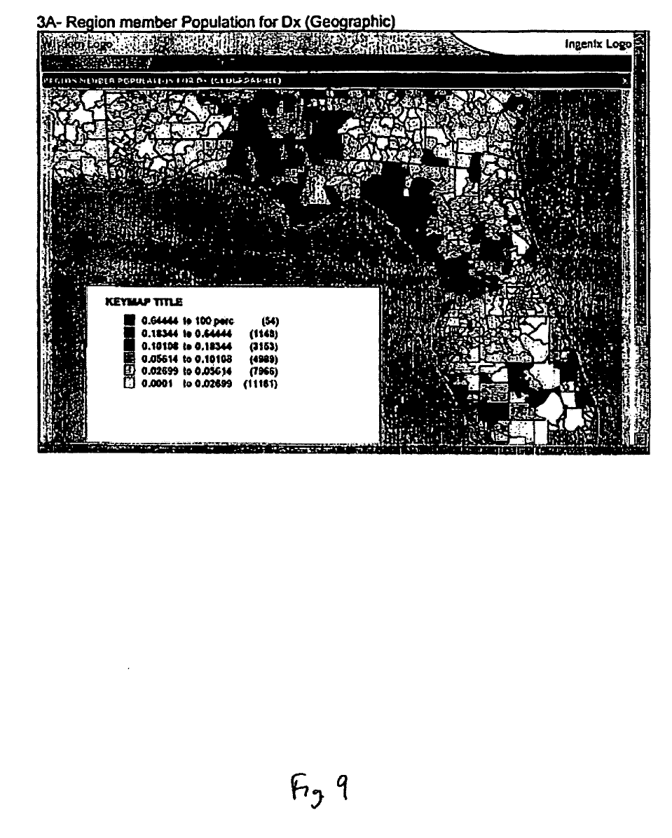

FIG. 10 illustrates an example of a display screen showing treatment patterns that patients in the geographic region are receiving for the particular diagnosis. These displays may be provided in a similar format as described above with regard to display layouts for pattern analysis.

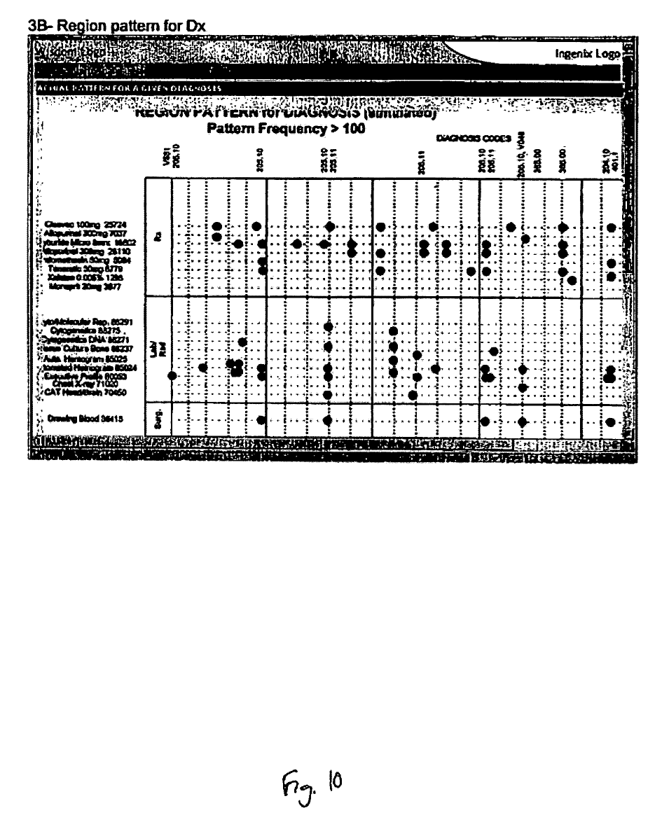

FIG. 11 illustrates another sample display screen wherein a profile of a medical service provider is shown. In one example, the display screen of FIG. 11 may include a list of the rarest diagnosis codes used by the provider, as well as the most common diagnosis codes used by the provider. For each entry in either the rarest diagnosis codes or the most common diagnosis codes, the fields may be provided for quantifying the total number of encounters with this diagnosis, the specific numbers of encounters with this diagnosis and the unique number of patients of this provider that have experienced this diagnosis, as well as a percentage quantifying the percentage of the providers patients that have been given this diagnosis. For instance, under the list of most common diagnosis codes used by the provider Dr. John Smith, hypertension has been diagnosed by this provider 11.12% of all the patients of this provider.

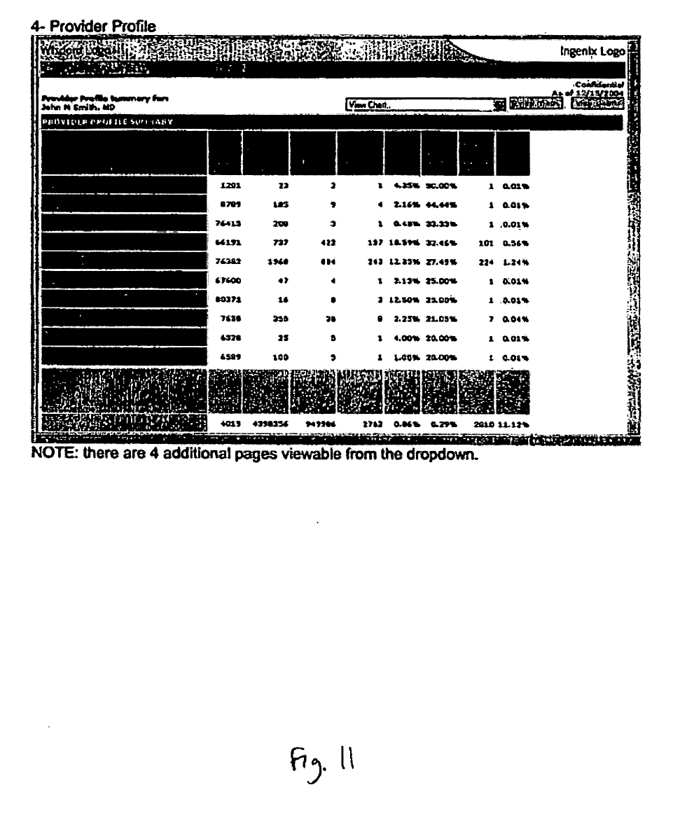

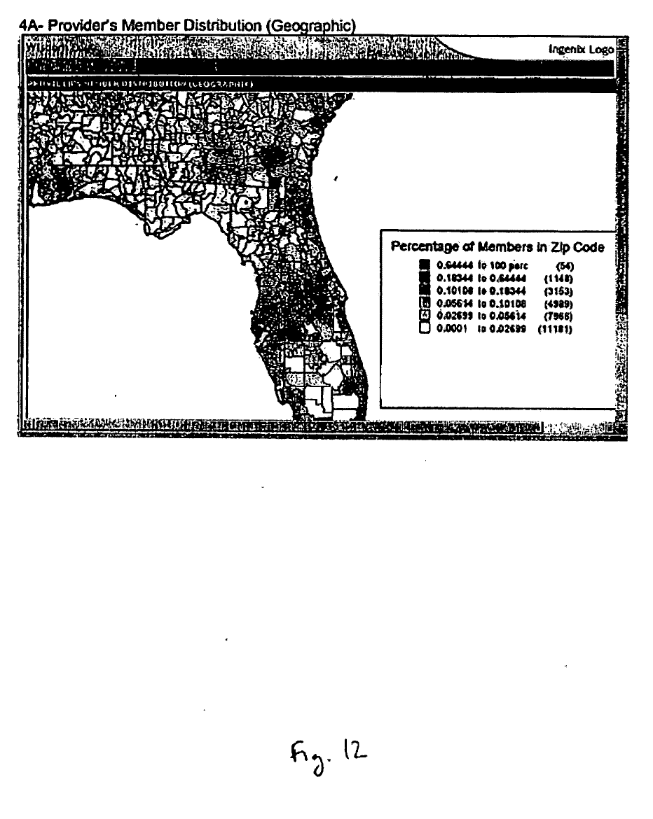

FIG. 12 illustrates an example display screen wherein the medical service providers distribution of membership is illustrated. FIG. 13 illustrates an example display screen wherein the details of claims data and treatments may be displayed for diagnosis/treatments made by a service provider. Here, the detailed report is provided for a single service provider, Dr. John Smith. Claims data detail may include a specialty code, a claimant identification, a service date, procedure codes, net paid amounts, amount submitted, and diagnosis codes. From the claimant ID link, a user may select this link in order to generate the individual patients' treatment pattern, such as was discussed above with regard to FIGS. 3-5.

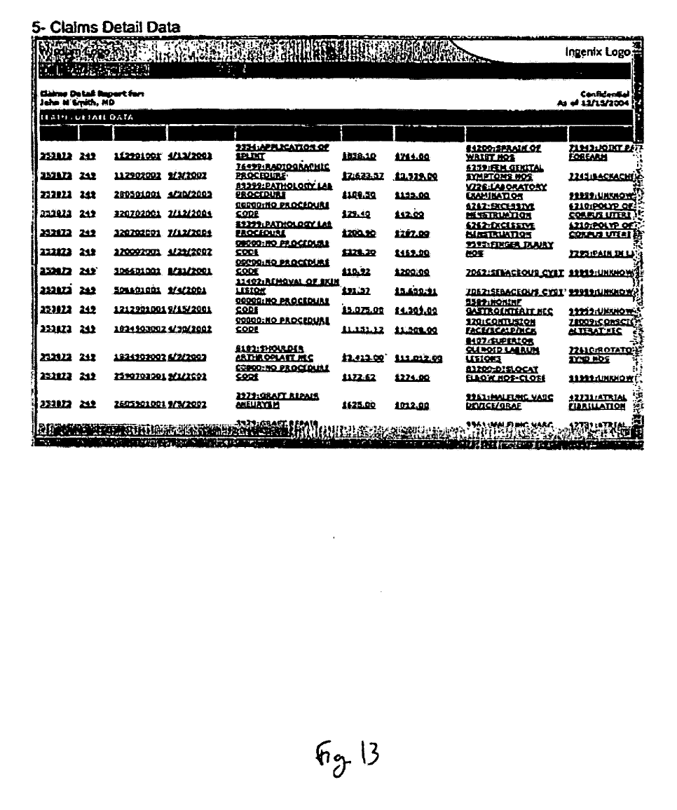

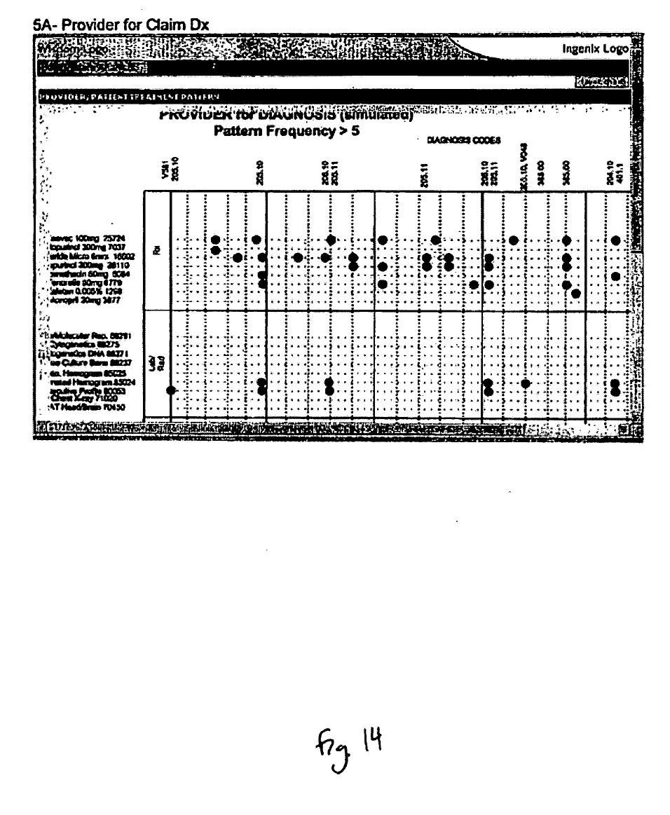

FIGS. 14-15 provide another example of a display of treatment pattern for an individual under the care of a particular service provider (FIG. 14), as well as an overlay (FIG. 15) between the treatment pattern for the individual compared against an evidenced based medicine practice pattern (events represented small squares in FIG. 15) which illustrates the differences between how the patient was treated for this particular diagnosis by this particular service provider against how an evidence based medicine practice pattern empirically treats such a diagnosis. From this comparison in FIG. 15, aberrations in treatment provided to the individual may be identified.

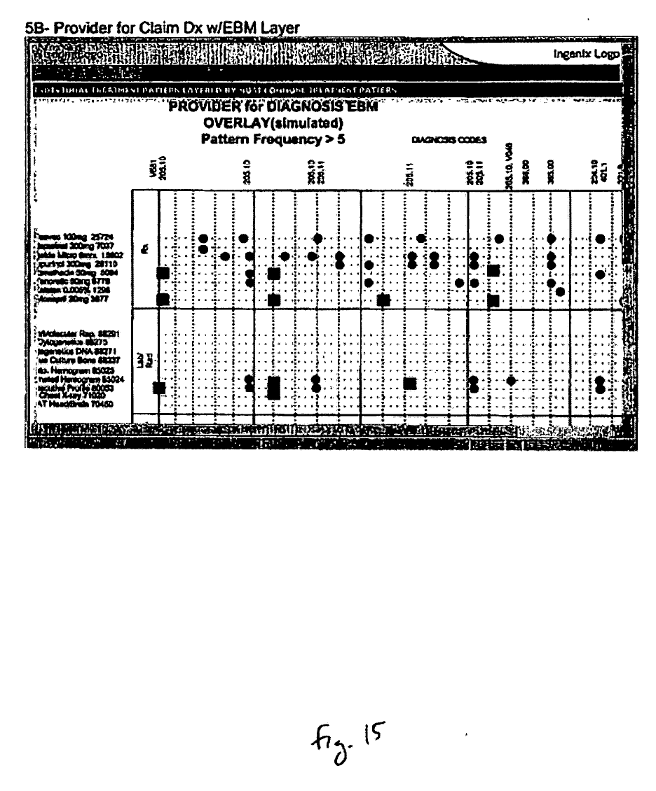

FIGS. 16-19 illustrate an example of a taxonomy or ordered groups of categories that can be utilized provide a user with control over how to analyze claims data within the claims database for addressing a particular need of the user. This taxonomy can be utilized in an attempt to standardize methods for the identification and classification of problem statements for which solutions based on analysis of healthcare data are created. The taxonomy illustrates how all of the different type of information sets can be grouped together to generate the pattern graphic.

By crafting a problem statement and a solution statement that conforms with the taxonomy, embodiments of the present invention can provide statistical analysis of healthcare claims data as well as relevant displays of results related to the particular problem statement formed.

In one example and as shown in FIG. 16, the taxonomy may include categories for quantitative elements, segment elements, sub segment elements, and entity elements which can be used to help define the problem statement that the user wishes to address. The taxonomy may also include categories including the market perspective, format, and view which may be utilized to form a solution statement to address the particular problem statement.

The quantitative elements category may include costs/efficiency, quality/effectiveness, value, and risk. The segment category may include group health, P&C, pharmaceuticals, government, employer. The sub segments may include HMO, PPO, TPA, indemnity, CMS, POS, consumer, auto, DOD, VA, in one example. The entity may include physician, hospital, lab, other professional, other facility, patient, pharmacy, in one example. The component category may include segment, entity type, specialty, geographic, demographic, data element, and derived, in one example. Inherent components may be included in the source data and may form a reference point between the entity category and the view category towards the development of a solution. Derived components may be developed from the source data to create a new level of grouping that is not inherently present in the source data, such as aggregation.

A view category may be provided which may include elements of pharmacy, research, subrogation, fraud, actuarial, claims administration, disease management, pricing and underwriting, network management, clinical operations, customer service administration, claims administration, claims administration, net work and provider management, utilization management, and employer, and one example. The views can represent the prospective of the organization utilizing the software as well as the characteristics of organizations within the industry.

A format category may also be included which may include elements of scorecard, summary, profile, trend, pattern, benchmark, and detail, and one example. The formats address the needs of a specific customer solution. The scorecard format can provide an overview which compares multiple entities within levels. Scorecards may also be used to compare individual or multiple, quantitative segment and entity summary levels in a numeric format. Comparative formats include the summary, profile, trend, pattern, and benchmark formats. The detail format provides the values (source data or derived data) directly.

The taxonomy may also include a market prospective category including elements of payer, patient, and provider in one example. The market perspective elements represent the prospective of the individual viewing the data, and can provide context in terms of the use and display of the data.

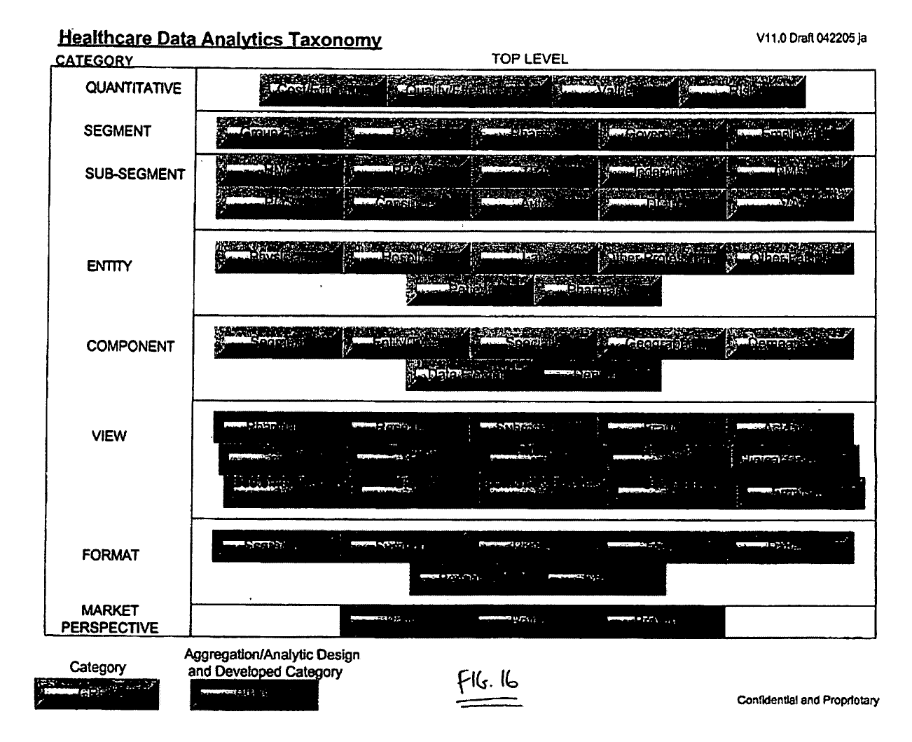

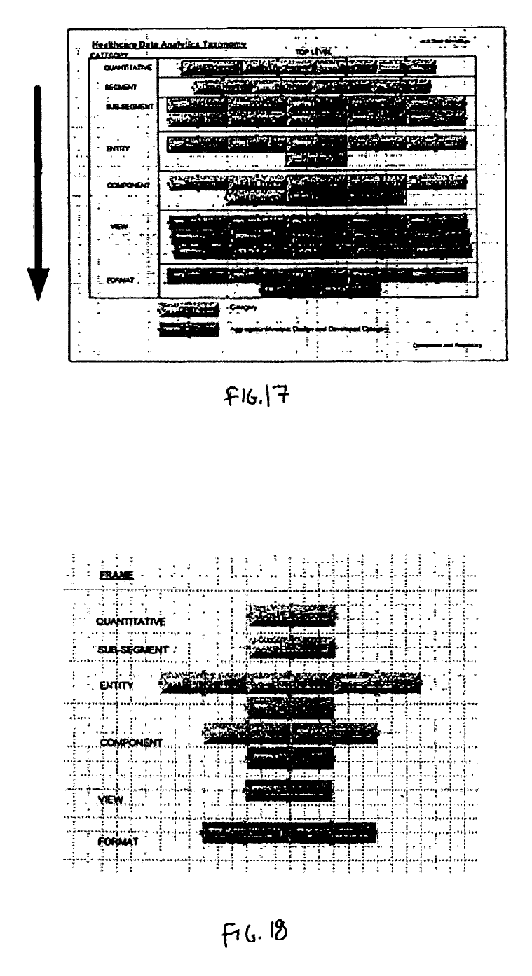

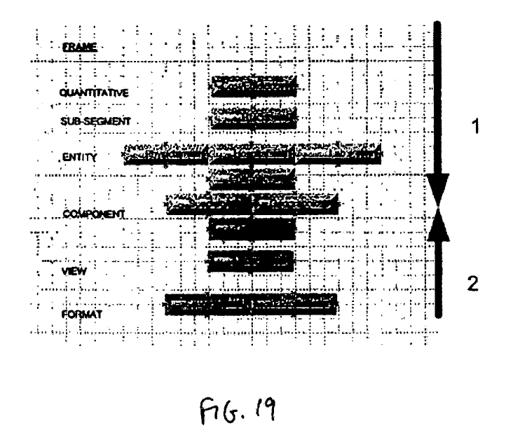

As shown in FIG. 17, a path from the top level of the taxonomy to the bottom level of the taxonomy may be identified to select applicable elements within the various categories as desired by the user. In FIG. 18, selected elements may be organized in order to frame a solution. In FIG. 19, a detailed problem statement can be defined having a specific goal within the elements selected. In creating the problem statement, the derived components to be used can be defined, as well as the applicable customers, views, and formats, that will be used. For instance, in FIG. 19, the problem statement may include “our organization needs to better understand COSTS within the HMO SUB SEGMENT related to PHYSICIAN/HOSPITAL/LAB/PHARMACY by SPECIALTY/GEOGRAPHY.” The solution statement may, in one example, states “to meet our problems we will use a SCORECARD/PROFILE FORMAT that answers our ACTUARIAL questions using DERIVED VALUES.”

Hence, it can be seen that embodiments of the present invention provide for identifying aberrations or important patterns in a patient's treatment for a medical condition.

Embodiments of the invention can be embodied in a computer program product. It will be understood that a computer program product including features of the present invention may be created in a computer usable medium (such as a CD-ROM or other medium) having computer readable code embodied therein. The computer usable medium preferably contains a number of computer readable program code devices configured to cause a computer to affect the various functions required to carry out the invention, as herein described.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment.

Furthermore, the particular features, structures or characteristics may be combined as desired in one or more embodiments of the invention.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, as the following claims reflect, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

What is claimed is:

1. A method for identifying aberrations in treatment pattern for a medical condition, comprising:
identifying a group of healthcare claim data to be analyzed, wherein the group of healthcare claim data to be analyzed comprises claim data representing treatment of the medical condition;
generating actual treatment pattern data representing the claim data in the group of healthcare claim data to be analyzed;
retrieving defined treatment pattern data for the medical condition;
comparing the actual treatment pattern data to the defined treatment pattern data to identify one or more discrepancies therebetween; and
generating comparison data representing the results of the comparison.

2. The method of claim 1, further comprising the step of:
displaying the actual treatment pattern data, the defined treatment pattern data, and the comparison data.

3. The method of claim 1, wherein the actual treatment pattern data represents a patient's treatment for the medical condition and the defined treatment pattern data represents treatment of a group of other patients for the medical condition.

4. The method of claim 1, wherein the actual treatment pattern data represents treatment of multiple patients for the medical condition by a healthcare provider and the defined treatment pattern data represents an established procedure for treatment of the medical condition.

5. The method of claim 4, wherein the established procedure is derived from evidence based medicine.

6. The method of claim 4, wherein the established procedure is derived from historical claim data analysis.

7. The method of claim 1, wherein the actual treatment pattern data includes treatment dates, categories of treatment, and a list of treatments provided.

8. The method of claim 1, further comprising the step of:
generating the defined treatment pattern data by identifying and compiling claim data relating to treatment of the medical condition from a database of historical claim data.

9. A system for identifying aberrations in treatment pattern for a medical condition, comprising:
a database for storing healthcare claim data; and
a processor for:
identifying a group of healthcare claim data to be analyzed, wherein the group of healthcare claim data to be analyzed comprises claim data representing treatment of the medical condition;
generating actual treatment pattern data representing the claim data in the group of healthcare claim data to be analyzed;
retrieving defined treatment pattern data for the medical condition;
comparing the actual treatment pattern data to the defined treatment pattern data to identify one or more discrepancies therebetween; and
generating comparison data representing the results of the comparison.

10. The system of claim 9, further comprising a display device for displaying the actual treatment pattern data, the defined treatment pattern data, and the comparison data.

11. The system of claim 9, wherein the actual treatment pattern data represents a patient's treatment for the medical condition and the defined treatment pattern data represents treatment of a group of other patients for the medical condition.

12. The system of claim 9, wherein the actual treatment pattern data represents treatment of multiple patients for the medical condition by a healthcare provider and the defined treatment pattern data represents an established procedure for treatment of the medical condition.

13. The system of claim 12, wherein the established procedure is derived from evidence based medicine.

14. The system of claim 12, wherein the established procedure is derived from historical claim data analysis.

15. The system of claim 9, wherein the actual treatment pattern data includes treatment dates, categories of treatment, and a list of treatments provided.

16. The system of claim 9, wherein the processor generating the defined treatment pattern data by identifying and compiling claim data relating to treatment of the medical condition from a database of historical claim data.

17. A system for identifying aberrations in treatment pattern for a medical condition, comprising:
means for storing healthcare claim data; and
means for identifying a group of healthcare claim data to be analyzed, wherein the group of healthcare claim data to be analyzed comprises claim data representing treatment of the medical condition;
means for generating actual treatment pattern data representing the claim data in the group of healthcare claim data to be analyzed;
means for retrieving defined treatment pattern data for the medical condition;
means for comparing the actual treatment pattern data to the defined treatment pattern data to identify one or more discrepancies therebetween; and
means for generating comparison data representing the results of the comparison.

18. The system of claim 17, wherein the actual treatment pattern data represents a patient's treatment for the medical condition and the defined treatment pattern data represents treatment of a group of other patients for the medical condition.

19. The system of claim 17, wherein the actual treatment pattern data represents treatment of multiple patients for the medical condition by a healthcare provider and the defined treatment pattern data represents an established procedure for treatment of the medical condition.

20. The system of claim 17, further comprising means for generating the defined treatment pattern data by identifying and compiling claim data relating to treatment of the medical condition from a database of historical claim data.
